(19) United States
(12) Patent Application Publication
(10) Pub. No.: US 2022/0180674 A1
(43) Pub. Date: Jun. 9, 2022

(54) Method and Apparatus for Determining Virtual Fault Code of Vehicle Controller

(71) Applicants: Hyundai Motor Company, Seoul (KR); Kia Corporation, Seoul (KR)

(72) Inventor: Byung Il Choi, Seoul (KR)

(21) Appl. No.: 17/507,962

(22) Filed: Oct. 22, 2021

(30) Foreign Application Priority Data
Dec. 9, 2020 (KR) 10-2020-0171548

(51) Int. Cl. G07C 5/08; G07C 5/00

(52) U.S. Cl. CPC G07C 5/0808; G07C 5/008

(57) ABSTRACT

A method of determining a virtual fault code of a vehicle controller includes determining whether fault code data of the vehicle controller is contained in vehicle state information received from the vehicle controller, determining whether the fault code data is the virtual fault code of the vehicle controller based on vehicle speed information and engine room hood state information, which are detected at a time when the fault code data is generated, when the fault code data of the vehicle controller is contained in the vehicle state information received from the vehicle controller, and determining that the fault code data is the virtual fault code of the vehicle controller when the vehicle speed is zero and the engine room hood state is in an open state.

### CROSS-REFERENCE TO RELATED APPLICATIONS

This application claims the benefit of Korean Patent Application No. 10-2020-0171548, filed on Dec. 9, 2020, which application is hereby incorporated herein by reference.

### TECHNICAL FIELD

The present disclosure relates to a method and apparatus for determining a virtual fault code of a vehicle controller.

### BACKGROUND

A large number of electric control units (ECUs) have been installed in vehicles due to installation of technologies of autonomous driving, electrification, and connectivity in vehicles.

ECUs in a vehicle perform cooperative control through various communication methods in order to perform complex functions and to ensure stability rather than independently and separating operating, and as the complexity increases, errors and failures frequently occur in the field after the development stage and mass production.

Thus, ECUs in a vehicle define the standard fault codes or independent fault codes for respective faults in order to monitor whether an ECU is normally operated, in which case, when an operation of a controller satisfies a condition in which a fault code is generated, the fault code is generated and is stored in a memory, and when a request command of an internal/external diagnostic device is generated, a controller transmits a fault code to the diagnostic device.

When the fault code is generated as described above, this means that a controller is not normally operated, and when the controller is not normally operated, the safety of a vehicle and an occupant may be affected.

Accordingly, as a simulation is executed based on various verifiable scenarios, a degree of completion of a controller is raised through an operation of overcoming a problem by monitoring whether a fault code is generated and recognizing the reason when the fault code is generated, but there is a limit in raising the degree of completion of the controller due to increase in the complexity of the controller.

In order to recognize the reason for a fault code, there is a special logging device for storing all of a fault code, a communication log before/after the fault code is generated, and vehicle sensor data, but it is disadvantageous that the special logging device requires large investment due to the high price.

Accordingly, when there is no special logging device, a general simple type logging device for collecting only a fault code and several pieces of vehicle sensor data is used.

However, the general logging device does not store a communication log before/after the fault code is generated, and thus it is difficult to recognize whether the collected fault code is generated due to an actual problem of a controller, an intended work (rework), or disconnection of a connector for any reason.

In particular, when a small number of managers need to simultaneously manage several tens and several hundreds of vehicles, it takes a lot of time to recognize the reason for the fault code as described above.

Accordingly, there is a need to determine whether a corresponding fault code is an actual fault code due to an actual software error of a controller or a virtual fault code due to an intended work or disconnection of a connector for a predetermined reason.

### SUMMARY

The present disclosure relates to a method and apparatus for determining a virtual fault code of a vehicle controller. Particular embodiments relate to a method and apparatus for determining a virtual fault code of a vehicle controller for easily determining whether a fault code generated in a vehicle controller is a virtual fault code.

One embodiment of the present disclosure provides a method and apparatus for determining a virtual fault code of a vehicle controller for determining whether a fault code generated in a vehicle controller is a virtual fault code generated due to intended work but not an actual fault of the controller.

An embodiment of the present disclosure provides a method of determining a virtual fault code of a vehicle controller, including a first operation of determining whether fault code data of a controller is contained in vehicle state information received from the vehicle controller, a second operation of determining whether the fault code data is a virtual fault code of a first controller based on vehicle speed information and engine room hood state information, which are detected at a time when the fault code data is generated, when the fault code data of the controller is contained in the vehicle state information received from the controller, and a third operation of determining that the fault code data is the virtual fault code of the first controller when the vehicle speed information is zero (0) and the engine room hood state information is in an open state.

Here, the first controller may be a controller installed in a vehicle engine room among vehicle controllers.

According to an embodiment of the present disclosure, the method may further include, when determining that the fault code data is the virtual fault code of the first controller, generating an outlier label in the fault code data.

According to another embodiment of the present disclosure, the method may further include, when determining the fault code data is the virtual fault code of the first controller, comparing the fault code data with a predetermined error fault code, and when the fault code data is the same as the error fault code, generating an outlier label in the fault code data.

The second operation may include determining that the fault code data is not the virtual fault code of the first controller when the vehicle speed information is zero (0) and the engine room hood state information is in a closed state.

The second operation may include determining that the fault code data is not the virtual fault code of the first controller when the vehicle speed information is not zero (0) and the engine room hood state information is in a closed state.

The second operation may include determining that the fault code data is not the virtual fault code of the first controller when the vehicle speed information is not zero (0) and the engine room hood state information is in an open state.

An embodiment of the present disclosure provides an apparatus for determining a virtual fault code of a vehicle controller, including vehicle controllers configured to, when fault code data is generated, match vehicle speed information and engine room hood state information, which are detected at a time when the fault code data is generated, with the fault code data, and to store the matched information, and a vehicle data collector configured to determine whether the fault code data is a virtual fault code of a first controller based on the vehicle speed information and the engine room hood state information, which are detected at the time when the fault code data is generated, when the fault code data of the controller is contained in the vehicle state information received from the controller, and to determine that the fault code data is the virtual fault code of the first controller when the vehicle speed information is zero (0) and the engine room hood state information is in an open state.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a diagram showing an example of the configuration of a system for performing a method of determining a virtual fault code of a vehicle controller according to embodiments of the present disclosure;

FIG. 2 is a graph for explaining a method of determining a virtual fault code of a vehicle controller according to embodiments of the present disclosure;

FIG. 3 is a diagram showing an example of the configuration of another system for performing a method of determining a virtual fault code of a vehicle controller according to embodiments of the present disclosure; and

FIG. 4 is a flowchart showing an example of a method of determining a virtual fault code of a vehicle controller according to embodiments of the present disclosure.

### DETAILED DESCRIPTION OF ILLUSTRATIVE EMBODIMENTS

The present disclosure will now be described more fully with reference to the accompanying drawings, in which exemplary embodiments of the present disclosure are shown. Expressions shown in the accompanying drawings are given to gain a sufficient understanding of exemplary embodiments of the present disclosure and may be different from actual products.

Throughout the specification, when a certain part “includes” a certain component, this indicates that the part may further include another component instead of excluding another component unless there is no different disclosure.

The present disclosure relates to a method of determining a virtual fault code of a controller for a vehicle and provides a method of determining a virtual fault code for determining whether a fault code in a vehicle controller is generated due to an error that actually causes a fault code in the controller.

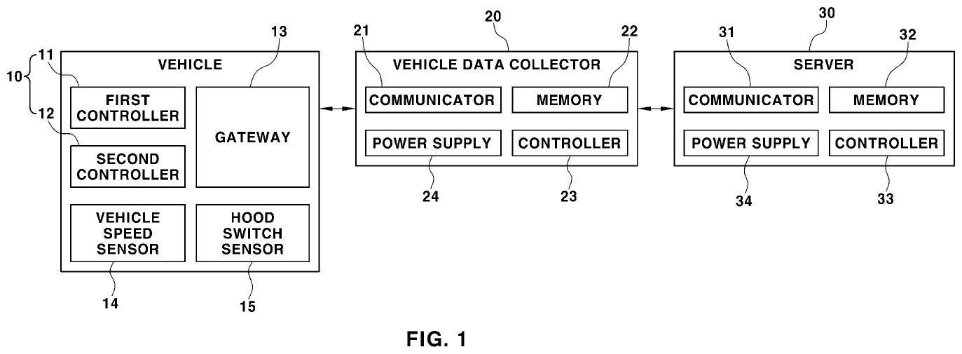

FIG. 1 is a diagram showing the configuration of a system for performing a method of determining a virtual fault code of a vehicle controller according to embodiments of the present disclosure.

As shown in FIG. 1, a plurality of controllers 10 may be installed in a vehicle. Each of the controllers 10 may be configured to perform an operation such as recognition, control, and determination alone for performing a function to be performed in the vehicle, and may also perform cooperative control while exchanging a signal with each other.

The controllers 10 in the vehicle may be electrically connected to each other in order to perform cooperative control, and may exchange signals with each other through a wiring harness.

The controllers 10 present in different domains in a vehicle may be connected to each other through a gateway 13. In other words, the gateway 13 may route signals in the controllers 10 in different domains in the vehicle. The controllers 10 may route the signals as necessary by connecting most of the controllers 10 installed in the vehicle to the gateway 13. The gateway 13 may be installed in the vehicle together with the controller 10.

The controller 10 and the gateway 13 may also be connected through the wiring harness to exchange signals with each other, and connectors for electric connection may be disposed at opposite ends of the wiring harness.

Here, the controller 10 may be classified into a first controller 11 and a second controller 12. In detail, it may be assumed that a powertrain controller among the controllers in the vehicle is the first controller 11, and a controller other than the powertrain controller among the controllers in the vehicle is the second controller 12.

The powertrain may be a device for transferring power generated in an engine to a wheel, and in detail may collectively refer to a clutch, a torque converter, a transmission, a propeller shaft, a drive shaft, a differential, and so on.

Here, the powertrain controller refers to controllers for controlling the overall operation of a powertrain, and is installed and disposed in an engine of the vehicle.

Accordingly, the first controller 11 may refer to a controller installed in an engine room among controllers in the vehicle, and the second controller 12 may refer to a controller installed outside the engine room among the controllers in the vehicle. In detail, the first controller 11 may be an electric control unit (ECU), a transmission control unit (TCU), or the like.

The controller 10 in the vehicle may be communicatively connected to a vehicle data collector 20 through the gateway 13.

The vehicle data collector 20 may be configured to collect vehicle state information containing fault code data of the controller 10, to determine whether the fault code data received from the controller 10 is a virtual fault code, and to communicate with a server 30 outside the vehicle.

In detail, the vehicle data collector 20 may include a collector communicator 21, a collector memory 22, and a collector controller 23.

The collector communicator 21 may be communicatively connected to the gateway 13 of the vehicle by wire or wirelessly. The collector communicator 21 may receive the fault code data generated in the controller 10 in the vehicle and various data output from a sensor in the vehicle, and as necessary may transmit a control signal of the collector controller 23 to the gateway 13 by communicating with the gateway 13.

The collector communicator 21 may communicate with the gateway 13 in the vehicle with a period predetermined by a user.

The collector controller 23 may determine whether to generate an outlier label in the fault code data by operating a predetermined control algorithm.

In detail, the collector controller 23 may determine whether the fault code data is a virtual fault code based on the vehicle state information transmitted from the controller 10, and when determining that the fault code of the controller 10 is the virtual fault code, the collector controller 23 may perform an operation of selectively generating an outlier label in the fault code data.

The collector memory 22 may store various data received through the collector communicator 21 and data output from the collector controller 23. In detail, the collector memory 22 may be configured to temporarily store the fault code data in which the outlier label is generated among data output from the collector controller 23.

The vehicle data collector 20 may also include a collector power supply 24 for supplying power required for an operation.

The vehicle data collectors 20 and 20′ may be a kind of terminal that is configured separately from the vehicle as shown in FIG. 1 or may be a kind of controller installed inside the vehicle as shown in FIG. 3. When the vehicle data collector 20′ is installed in the vehicle, it may be possible to use the gateway 13, and accordingly a separate communicator may not be required.

It may also be possible to install a separate controller for performing the functions of the vehicle data collector 20 and the gateway 13 in the vehicle.

The vehicle state information may include controller fault code data and vehicle sensor data detected and output by various sensors installed in the vehicle.

As shown in FIG. 1, the sensor data may include output information of a hood switch sensor 15 for detecting an opening and closing operation of a hood for opening and closing an engine room of a vehicle, output information of a vehicle speed sensor 14 for detecting vehicle speed, and so on.

As shown in FIG. 1, the server 30 may include a server communicator 31, a server memory 32, and a server controller 33.

The server communicator 31 may be configured to communicate with the collector communicator 21. The server communicator 31 may receive the fault code data stored in the collector memory 22, and as necessary may transmit a control signal of the server controller 33 to the collector communicator 21 by communicating with the collector communicator 21.

The server controller 33 may perform various operations of determination, analysis, and generation of a control signal, which are required by a user, based on the data stored in the server memory 32. For example, when analyzing the controller fault code stored in the server memory 32, the server controller 33 may analyze the fault code except for the fault code data in which the outlier label is generated.

The server memory 32 may store the actual fault code data, the virtual fault code data, and so on, transmitted from the vehicle data collector 20, and may also store various previously established databases. The virtual fault code data may include the fault code data in which the outlier label is generated.

A standard fault code or an independent fault code may be determined based on fault details in order to monitor whether the controllers 10 of the vehicle are normally operated, and each of the controllers 10 may transmit and store the generated fault code to and in the server memory 32.

When a fault corresponding to a predetermined condition is generated in each of the controllers 10 of the vehicle, the fault code may be autonomously generated and may be stored in an internal memory, and the fault code data may be transmitted to the vehicle data collector 20 according to a request of the vehicle data collector 20. The vehicle data collector 20 may transmit and store the fault code data and so on, which are received from the controllers 10, to and in the server 30.

The server 30 may also include a server power supply 34 for supplying power required for an operation.

In order to rework the first controller 11 installed in the engine room of the vehicle, a connector connected to the first controller 11 needs to be disconnected, and after the first controller 11 is completely reworked, a connector may be installed again in the first controller 11.

In more detail, in order to rework the first controller 11, an engine room hood may be opened by opening a driver's door and manipulating an engine room hood switch inside the vehicle in a stopped state in which a vehicle speed is zero (0). Then, when the connector is disconnected and removed from the first controller 11, and the first controller 11 is completely reworked, the connector may be coupled to the first controller 11 again, and then the engine room hood may be closed.

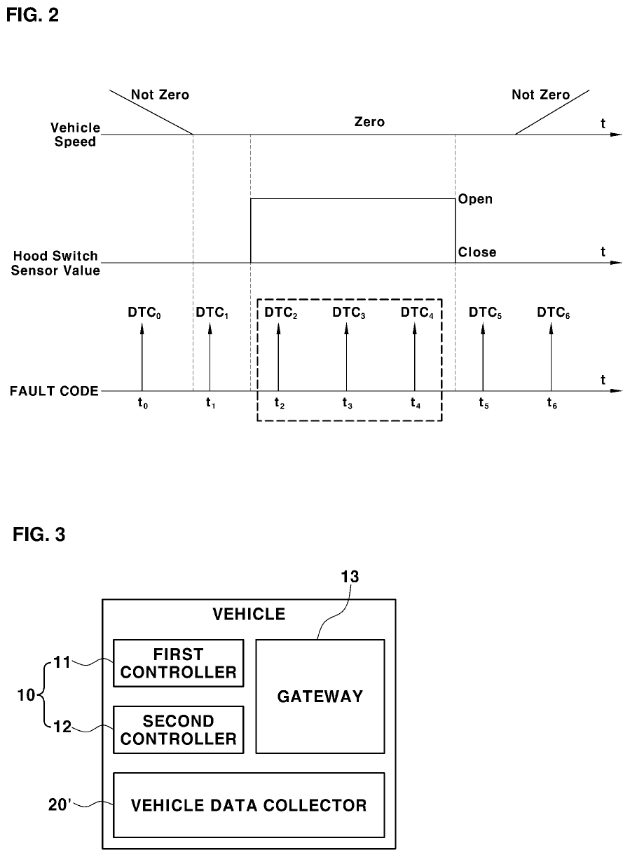

Thus, as shown in FIG. 2, the collector controller 23 may first determine whether the fault code of the first controller 11 is a virtual fault code generated due to a rework situation based on vehicle speed information and engine room hood state information, which are collected together at the time when the fault code of the first controller 11 is generated.

Referring to FIG. 2, fault codes DTC2, DTC3, and DTC4, which are generated when a vehicle speed is zero (0) and the engine room hood is in an open state, each may be determined to be a virtual fault code.

When storing a fault code, the controller 10 in the vehicle may match the vehicle speed information and the engine room hood state information, which are detected at the time when the fault code is generated, with the fault code and may store the matched information together. In this case, the controllers 10 may respectively receive the vehicle speed information and the engine room hood state information from the vehicle speed sensor 14 and the hood switch sensor 15 installed in the vehicle or may receive the vehicle speed information and the engine room hood state information from other controllers for collecting information of the vehicle speed sensor 14 and the hood switch sensor 15. The engine room hood state information may be recognized based on an output value of the hood switch sensor 15 for detecting an engine room hood switch state value.

For example, when the first controller 11 generates a predetermined fault code (i.e., a first fault code), the first controller 11 may receive the vehicle speed information and/or the engine room hood state information from the vehicle speed sensor 14 and the hood switch sensor 15 or may receive the vehicle speed information and/or the engine room hood state information from the second controller 12, and the first controller 11 may match the vehicle speed information and the engine room hood state information with the first fault code and may store the matched information in an internal memory of the first controller 11. In this case, when storing the first fault code, the vehicle speed information, and the engine room hood state information, the first controller 11 may mutually distinguishably store other fault codes and vehicle state information generated at different times.

The collector controller 23 may finally determine whether to generate an outlier label in the fault code data of the first controller 11 by comparing the virtual fault code that is first determined as described above with an error fault code stored in an error fault code database of the server memory 32.

A fault code is generated when a connector of a controller is mainly related to a communication error or a circuit error, and thus an error fault code of the controller 10 may be stored in the form of a database in the server memory 32.

Thus, the accuracy about whether an outlier label is generated may be improved by comparing the fault code generated in the first controller 11 with the error fault code stored in the server memory 32.

Whether the label is generated may also be determined by the server controller 33. To this end, the server 30 may receive the vehicle state information from the vehicle data collector 20 and may store the same in the server memory 32. That is, the entire vehicle state information collected by the vehicle data collector 20 may be transmitted to the server 30, and the server 30 may determine whether to generate an outlier label in the fault code, and may selectively generate the outlier label according to the determination result.

When the vehicle speed data or the engine room hood state data does not satisfy a predetermined condition, the collector controller 23 may not be capable of determining that the current situation is a normal rework situation, and thus may determine that the possibility that an actual error of a controller is high and may determine that it is required to recognize the accurate reason through actual vehicle inspection and to improve the vehicle.

When the vehicle travels in the state in which the engine room hood is open, the collector controller 23 may determine that the current state is an abnormal driving state. In this case, a visual or auditory warning message may be continuously transferred to a driver through a display device of a vehicle, such as a cluster, or a speaker of the vehicle.

The fault code generated in the controller 10 may be a code having predetermined ciphers, and the fault code may include a standard fault code having predetermined ciphers and an additional information fault code positioned behind the standard fault code. The standard fault code may define and indicate details of the same fault of the controllers 10 and the additional information fault code may define and indicate details of individual faults for debugging of each of the controllers 10.

For example, assuming that the fault code is P123456, P1234 is a standard fault code, and 56 is an additional information fault code.

When comparing the fault code of the controller 10 with the error fault code stored in the server memory 32, the collector controller 23 may determine whether the fault code of the controller 10 and the error fault code stored in the server memory 32 are the same via sequential comparison from the uppermost cipher.

When there is the error fault code that is completely the same as the fault code of the first controller 11, the collector controller 23 may immediately generate an outlier label, and when there is no error fault code which is completely the same as the fault code of the first controller 11 in the server memory 32, comparison may be performed only on the standard fault code of the error fault code.

When there is the error fault code that is the same as the fault code of the first controller 11 based on the comparison result only on the standard fault code, the collector controller 23 may generate an outlier label in a controller fault code.

In other words, the collector controller 23 may generate an outlier label in the controller fault code even if a code up to a predetermined cipher from the uppermost cipher of the controller fault code is the same as the error fault code.

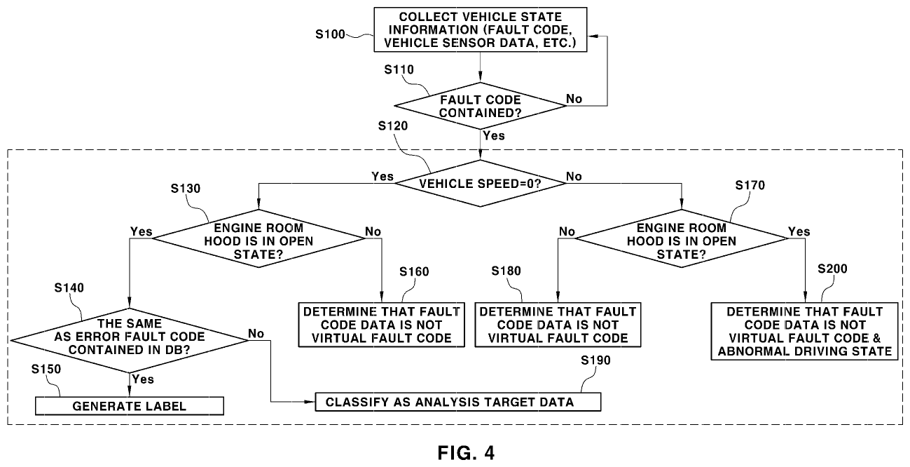

Hereinafter, a method of determining a virtual fault code of a vehicle controller according to embodiments of the present disclosure will be described with reference to FIG. 4.

As shown in FIG. 4, the vehicle data collector 20 may periodically collect vehicle state information through communication with the gateway 13 in a vehicle (S100).

In operation S100, the vehicle data collector 20 may make a request to the controller 10 in the vehicle for the fault code data and the vehicle sensor data, and the controllers 10, which receive the request of the vehicle data collector 20, may transmit fault code data and vehicle sensor data that are stored therein to the vehicle data collector 20. In this case, the vehicle data collector 20 may receive the fault code data and the vehicle sensor data through the collector communicator 21 and may store the received data in the collector memory 22.

Then, the collector controller 23 of the vehicle data collector 20 may determine whether there is fault code data of the controller 10 among the received vehicle state information (S110). When there is no fault code data of the controller 10, operation S100 may be repeatedly performed.

When there is fault code data of the controllers 10, whether vehicle speed of the vehicle sensor data is zero (0) may be determined (S120).

When the vehicle speed is zero, the collector controller 23 may determine whether an engine room hood is in an open state based on the information of the hood switch sensor 15 (S130).

When determining that the engine room hood is in an open state in operation S130, the collector controller 23 may first determine that the fault code of the controller 10 is a virtual fault code, but not an actual fault code, and may determine whether the fault code of the controller 10, determined to be the virtual fault code, is the same as an error fault code stored in the server memory 32 (S140). In this case, the collector controller 23 may determine that the fault code of the controller 10 is the virtual fault code of the first controller 11 and may compare the error fault code stored in the server memory 32 with the error fault code of the first controller 11.

Then, when the fault code data of the controller 10 is the same as the error fault code stored in the server memory 32, the collector controller 23 may generate an outlier label in the fault code data of the controller 10 (S150). In the case of the fault code in which an outlier label is generated, outlier processing may be performed when the controller fault code is analyzed.

When the fault code data of the controller 10 is not the same as the error fault code stored in the server memory 32 in operation S140, the collector controller 23 may first determine that the fault code data of the controller 10 is the virtual fault code in operation S130 but may determine and classify the fault code data of the controller 10 to be analysis target data that needs to be precisely inspected in an actual vehicle (S190).

When the engine room hood is in a closed state as the determination result in operation S130, the collector controller 23 may determine that the fault code data of the controller 10 is not the virtual fault code of the first controller 11 (S160). In this case, the fault code of the controller 10 may be a virtual fault code due to a rework situation of the second controller 12 or a progressive fault code generated in a stop state, and accordingly the fault code data of the controller 10 may be determined and classified to be analysis target data (S190).

When determining that the vehicle speed is not zero (0) in operation S120, the collector controller 23 may determine whether the engine room hood is in an open state (S170).

When the engine room hood is in a closed state in operation S110, the collector controller 23 may determine that the fault code data of the controller 10 is not the virtual fault code of the first controller 11 (S180). In this case, the fault code of the controller 10 may be the progressive fault code generated in a driving state, and accordingly the fault code data of the controller 10 may be determined and classified to be the analysis target data (S190).

When the engine room hood is in an open state in operation S170, the collector controller 23 may determine that the fault code data of the controller 10 is not the virtual fault code of the first controller 11 and simultaneously may determine that the current state is an abnormal driving state (S200).

According to the aforementioned solutions, embodiments of the present disclosure may easily determine whether a fault code generated in a controller in a vehicle is a virtual fault code generated due to an intended disconnection of a connector instead of an actual fault code of the controller by using vehicle sensor data, and accordingly the time taken to recognize the reason for the fault code may be reduced and the accuracy, reliability, and ease of data analysis may be maximized by previously recognizing fault code data on which outlier processing is performed when big data is analyzed in order to improve the quality of the controller.

The present disclosure has been described in detail with reference to preferred embodiments thereof, and terms or words used herein shall not be limited to having common or dictionary meanings. In addition, embodiments described in the specification and components shown in the drawings are merely exemplary embodiments of the present disclosure and do not represent all technological features of the present disclosure, and thus, it is to be appreciated that various equivalents and modifications can be made to substitute the features.

What is claimed is:

1. A method of determining a virtual fault code of a vehicle controller, the method comprising:
determining whether fault code data of the vehicle controller is contained in vehicle state information received from the vehicle controller;
determining whether the fault code data is a virtual fault code of the vehicle controller based on vehicle speed information and engine room hood state information, which are detected at a time when the fault code data is generated, when the fault code data of the vehicle controller is contained in the vehicle state information received from the vehicle controller; and
determining that the fault code data is the virtual fault code of the vehicle controller when the vehicle speed is zero and the engine room hood state is in an open state.

2. The method of claim 1, wherein the vehicle controller is a controller installed in a vehicle engine room among a plurality of vehicle controllers.

3. The method of claim 1, further comprising, when determining that the fault code data is the virtual fault code of the vehicle controller, generating an outlier label in the fault code data.

4. The method of claim 1, further comprising:
when determining the fault code data is the virtual fault code of the vehicle controller, comparing the fault code data with a predetermined error fault code; and
when the fault code data is the same as the error fault code, generating an outlier label in the fault code data.

5. The method of claim 1, wherein the second operation comprises determining that the fault code data is not the virtual fault code of the vehicle controller when the vehicle speed is zero and the engine room hood state is in a closed state.

6. The method of claim 1, wherein the second operation comprises determining that the fault code data is not the virtual fault code of the vehicle controller when the vehicle speed is not zero and the engine room hood state is in a closed state.

7. The method of claim 1, wherein the second operation comprises determining that the fault code data is not the virtual fault code of the vehicle controller when the vehicle speed is not zero and the engine room hood state is in the open state.

8. An apparatus for determining a virtual fault code of a vehicle controller, the apparatus comprising:
vehicle controllers configured to, when fault code data is generated, match vehicle state information including vehicle speed information and engine room hood state information, which are detected at a time when the fault code data is generated, with the fault code data, and to store the matched information; and
a vehicle data collector configured to determine whether the fault code data is a virtual fault code of a first controller of the vehicle controllers based on the vehicle speed information and the engine room hood state information, which are detected at the time when the fault code data is generated, when the fault code data of the first controller is contained in the vehicle state information received from the first controller, and to determine that the fault code data is the virtual fault code of the first controller when the vehicle speed is zero and the engine room hood state is in an open state.

9. The apparatus of claim 8, wherein the first controller is a controller installed in a vehicle engine room among the vehicle controllers.

10. The apparatus of claim 8, wherein, when determining that the fault code data is the virtual fault code of the first controller, the vehicle data collector is configured to generate an outlier label in the fault code data.

11. The apparatus of claim 8, wherein, when determining the fault code data is the virtual fault code of the first controller, the vehicle data collector is configured to compare the fault code data with a predetermined error fault code.

12. The apparatus of claim 11, wherein, when the fault code data is the same as the error fault code, the vehicle data collector is configured to generate an outlier label in the fault code data.

13. The apparatus of claim 8, wherein the vehicle data collector is configured to determine that the fault code data is not the virtual fault code of the first controller when the vehicle speed is not zero or the engine room hood state is not in an open state.

14. A method of interpreting fault code data of a vehicle controller, the method comprising:
generating fault code data of a vehicle controller;
detecting vehicle speed information and engine room hood state information at a time when the fault code data is generated, the vehicle speed information indicating that the vehicle speed is zero and the engine room hood state information indicating that the engine room hood state is in an open state; and
determining that the fault code data is a virtual fault code of the vehicle controller based on detecting that the vehicle speed is zero and the engine room hood state is in the open state.

15. The method of claim 14, wherein the vehicle controller one of a plurality of vehicle controllers installed in the engine room.

16. The method of claim 14, further comprising generating an outlier label in the fault code data in response to determining that the fault code data is a virtual fault code of the vehicle controller.

17. The method of claim 14, further comprising:
comparing the fault code data with a predetermined error fault code in response to determining that the fault code data is a virtual fault code of the vehicle controller; and
generating an outlier label in the fault code data when the fault code data is the same as the error fault code.

18. The method of claim 14, further comprising:
generating second fault code data of the vehicle controller; and
detecting second vehicle speed information and second engine room hood state information at a time when the second fault code data is generated, the second vehicle speed information indicating that the vehicle speed is zero and the second engine room hood state information indicating that the engine room hood state is in a closed state; and
determining that the fault code data is not a virtual fault code of the vehicle controller based on detecting that the second vehicle speed is zero and the second engine room hood state is in the closed state.

19. The method of claim 14, further comprising:
generating second fault code data of the vehicle controller; and
detecting second vehicle speed information and second engine room hood state information at a time when the second fault code data is generated, the second vehicle speed information indicating that the vehicle speed is not zero and the second engine room hood state information indicating that the engine room hood state is in a closed state; and
determining that the fault code data is not a virtual fault code of the vehicle controller based on detecting that the second vehicle speed is not zero and second the engine room hood state is in the closed state.

20. The method of claim 14, further comprising:
generating second fault code data of the vehicle controller; and
detecting second vehicle speed information and second engine room hood state information at a time when the second fault code data is generated, the second vehicle speed information indicating that the vehicle speed is not zero and the second engine room hood state information indicating that the engine room hood state is in the open state; and
determining that the fault code data is not the virtual fault code of the vehicle controller based on detecting that the second vehicle speed is not zero and the second engine room hood state is in the open state.
